(19) United States
(12) Patent Application Publication
(10) Pub. No.: US 2003/0189354 A1
(43) Pub. Date: Oct. 9, 2003

(54) Hinge assembly and method for manufacturing same

(75) Inventor: Tony Fabiano, Newmarket (CA)

Correspondence Address: PILLSBURY WINTHROP, LLP, P.O. BOX 10500, MCLEAN, VA, 22102, US

(73) Assignee: VENTRA GROUP INC., Bradford (CA)

(21) Appl. No.: 10/400,545

(22) Filed: Mar. 28, 2003

Related U.S. Application Data
(60) Provisional application No. 60/370,687, filed on Apr. 9, 2002.

(51) Int. Cl. B62D 25/00; B62D 33/00

(52) U.S. Cl. 296/57.1; 296/146.11

(57) ABSTRACT

A hinge assembly is provided including a first hinge member including a first mounting structure to mount the first hinge member to one of a vehicle closure member and a vehicle body. The first hinge member includes a rotatable member. The rotatable member and the first mounting structure may be integrally formed together from a single piece of metal. The hinge assembly includes a second hinge member including a second mounting structure to mount the second hinge member to the other of the vehicle closure member and the vehicle body. The second hinge member includes a wall portion to define a rotatable member receiving space. The rotatable member receiving space is configured to rotatably receive the rotatable member for enabling the first and second hinge members to pivot relative to one another. The wall portion and the second mounting structure may be integrally formed together from a single piece of metal.

### BACKGROUND OF THE INVENTION

The present application claims priority to U.S. Provisional Application Serial No. 60/370,687, the entirety of which is hereby incorporated into the present application by reference.

1. Field of the Invention

This invention relates to hinges and more particularly to a hinge of a type used on automotive tailgates.

2. Description of Related Art

Cup-type hinges are used in the automotive industry, for example, to provide pivotal movement of a tailgate on a truck or sport utility vehicle (SUV). For this type of application, a pair of first hinge members are attached to opposite sides of the tailgate adjacent a lower edge thereof and a corresponding pair of second hinge members are mounted to the vehicle within the tailgate opening. One pair of hinge members have hinge cups that rotatably receive shaft elements of the other pair of hinge members. The hinge cups and the shaft elements are rotatable relative to one another to allow the tailgate to pivot relative to the tailgate opening between the open and closed positions.

In this manner, the tailgate is supported by the cup hinges in a cantilevered manner when the tailgate is in the open position. Accordingly, the hinges must be relatively strong to support the tailgate, especially since one of the contemplated uses for tailgates is temporarily supporting objects while facilitating loading and unloading of the truck or SUV. Cup hinges typically have a multi-piece joining of individual components to form the hinge members. The multi-piece construction of these hinges, however, may not provide adequate strength due to an inherent weakness between the joined components. In particular, the hinge cup is usually joined to a bracket of the hinge member by a process such as welding or staking (pinning) the hinge cup to the bracket. Accordingly, the hinge has a weakness within the joined area, either the weld or staked material.

Additionally, the hinge cups and shaft elements must be held in relatively precise alignment with the brackets during the joining process to ensure proper operation of the tailgate. In particular, if one or both of the cups are tilted relative to the pivot axis, the pivotal movement of the tailgate may be hindered. This practice, as well as the secondary operations of welding or staking to join the components, increases manufacturing costs of the hinges.

### SUMMARY OF THE INVENTION

One aspect of the present invention provides a hinge assembly for pivotally connecting a vehicle closure member to a vehicle body. The hinge assembly includes a first hinge member including a first mounting structure configured to mount the first hinge member to one of the vehicle closure member and the vehicle body. The first hinge member also includes a rotatable member extending from the first mounting structure and defining a pivot axis. The rotatable member and the first mounting structure are integrally formed together from a single piece of metal. The hinge assembly also includes a second hinge member including a second mounting structure configured to mount the second hinge member to the other of the vehicle closure member and the vehicle body. The second hinge member also includes a wall portion extending from the second mounting structure to define a rotatable member receiving space. The rotatable member receiving space is configured to rotatably receive the rotatable member for enabling the first and second hinge members to pivot relative to one another about the pivot axis. The wall portion and the second mounting structure are integrally formed together from a single piece of metal.

Another aspect of the invention provides a hinge member for use with another hinge member to define a hinge assembly for pivotally connecting a vehicle closure member to a vehicle body. The other hinge member includes a mounting structure configured to mount the other hinge member to one of the vehicle closure member and the vehicle body and also includes a rotatable member extending from, but not necessarily integral with, the mounting structure and defines a pivot axis. The hinge member includes a mounting structure configured to mount the hinge member to the other of the vehicle closure member and the vehicle body and a wall portion extending from the mounting structure to define a rotatable member receiving space. The rotatable member receiving space is configured to rotatably receive the rotatable member of the other hinge member for enabling both hinge members to pivot relative to one another about the pivot axis. The wall portion and the mounting structure are integrally formed together from a single piece of metal.

Another aspect of the present invention provides a hinge member for use with another hinge member to define a hinge assembly for pivotally connecting a vehicle closure member to a vehicle body. The other hinge member includes a mounting structure configured to mount the other hinge member to one of the vehicle closure member and the vehicle body. The other hinge member also includes a wall portion extending from, but not necessarily integral with, the mounting structure to define a rotatable member receiving space. The hinge member includes a mounting structure configured to mount the hinge member to the other of the vehicle closure member and the vehicle body. A rotatable member extends from the mounting structure to define a pivot axis. The rotatable member is configured to be rotatably received in the shaft receiving space for enabling both the hinge members to pivot relative to one another about the pivot axis. The rotatable member and the mounting structure are integrally formed together from a single piece of metal.

Another aspect of the present invention provides a hinge system for pivotally connecting a vehicle closure member to a vehicle body. The hinge system includes a pair of hinge assemblies for installation in spaced apart relation between the vehicle closure member and the vehicle body. Each hinge assembly includes a first hinge member including a first mounting structure configured to mount the first hinge member to one of the vehicle closure member and the vehicle body. The first hinge member also includes and a rotatable member extending from the first mounting structure and defining a pivot axis. The rotatable member and the first mounting structure are integrally formed together from a single piece of metal. Each hinge assembly also includes a second hinge member including a second mounting structure configured to mount the second hinge member to the other of the vehicle closure member and the vehicle body. The second hinge member also includes a wall portion extending from the second mounting structure to define a rotatable member receiving space. The rotatable member receiving space is configured to rotatably receive the rotatable member for enabling the first and second hinge members to pivot relative to one another about the pivot axis. The wall portion and the second mounting structure are integrally formed together from a single piece of metal. The rotatable member of at least one of the hinge assemblies is oblong in cross-section and the wall portion of the at least one of the hinge assemblies defines an opening facing radially with respect to its associated pivot axis. The opening is configured to enable the oblong rotatable member, when oriented with its major axis aligned with the opening, to be moved through the opening so as to allow the first and second hinge members to be disengaged for enabling removal of the vehicle closure member from the vehicle body.

Another aspect of the invention provides a combination including a vehicle body, a vehicle closure member, and a hinge system. The hinge system includes a pair of hinge assemblies for installation in spaced apart relation between the vehicle closure member and the vehicle body. Each hinge assembly includes a first hinge member including a first mounting structure mounted to one of the vehicle closure member and the vehicle body and also includes a rotatable member extending from the first mounting structure and defines a pivot axis. The rotatable member and the first mounting structure are integrally formed together from a single piece of metal. A second hinge member includes a second mounting structure mounted to the other of the vehicle closure member and the vehicle body and also includes a wall portion extending from the second mounting structure to define a rotatable member receiving space. The rotatable member receiving space rotatably receives the rotatable member therein for enabling the first and second hinge members to pivot relative to one another about the pivot axis. The wall portion and the second mounting structure are integrally formed together from a single piece of metal. The rotatable member of at least one of the hinge assemblies is oblong in cross-section and the wall portion of the at least one of the hinge assemblies defines an opening facing radially with respect to the pivot axis. The opening is configured to enable the oblong rotatable member, when oriented with its major axis substantially aligned with the opening, to be moved through the opening so as to allow the first and second hinge members thereof to be disengaged for enabling removal of the vehicle closure member from the vehicle body.

Yet another aspect of the invention provides a method of forming a hinge member for use with another hinge member to define a hinge assembly for pivotally connecting a vehicle closure member to a vehicle body. The other hinge member includes a mounting structure configured to mount the another hinge member to one of the vehicle closure member and the vehicle body and also includes a rotatable member extending from the first mounting structure and defines a pivot axis. The method includes providing a one-piece metal blank and forming a wall portion protruding from the one-piece metal blank outwardly therefrom and to define a rotatable member receiving space. The rotatable member receiving space is configured to rotatably receive the rotatable member of the other hinge member for enabling both hinge members to pivot relative to one another about the pivot axis. The method also includes forming a mounting structure from the one-piece metal blank integral with the wall portion. The mounting structure is configured to mount the hinge member to the other of the vehicle closure member and the vehicle body.

Still another aspect of the invention provides a method of forming a hinge member for use with another hinge member to define a hinge assembly for pivotally connecting a vehicle closure member to a vehicle body. The other hinge member includes a mounting structure configured to mount the other hinge member to one of the vehicle closure member and the vehicle body and also includes a wall portion extending from the mounting structure to define a rotatable member receiving space. The method includes providing a one-piece metal blank and forming a rotatable member protruding from the one-piece metal blank outwardly therefrom. The rotatable member is configured to be rotatably received within the rotatable member receiving space of the other hinge member for enabling both hinge members to pivot relative to one another about the pivot axis. The method also includes forming a mounting structure from the one-piece metal blank integral with the rotatable member. The mounting structure is configured to mount the hinge member to the other of the vehicle closure member and the vehicle body.

Other aspects, features, and advantages will become apparent from the following detailed description, the accompanying drawings, and the appended claims.

### BRIEF DESCRIPTION OF THE DRAWINGS

FIGS. 1 and 2 are rear perspective views of a truck bed and tailgate showing the tailgate in its closed and open positions, respectively;

FIG. 3 is a perspective view of a first hinge member;

FIGS. 4-6 are side views showing details of the first hinge member shown in FIG. 3;

FIG. 7 is a perspective view of a second hinge member;

FIGS. 8-10 are side views showing details of the second hinge member shown in FIG. 7;

FIG. 11 is a perspective view of another embodiment of a first hinge member;

FIGS. 12-14 are side views showing details of the first hinge member shown in FIG. 11;

FIG. 15 is a perspective view of another embodiment of a second hinge member;

FIGS. 16-18 are side views showing details of the second hinge member shown in FIG. 15;

FIG. 19 is a cross-sectional view of first and second hinge members when the tailgate is in the closed position, taken about line I-I in FIG. 1;

FIG. 19A is a cross-sectional view of the first and second hinge members when the tailgate is in the closed position, taken about line II-II in FIG. 1;

FIG. 20 is a cross-sectional view of first and second hinge members when the tailgate is in the open position, taken about line III-III in FIG. 2;

FIG. 20A is a cross-sectional view of first and second hinge members when the tailgate is in the open position, taken about line IV-IV in FIG. 2;

FIG. 21 is a cross-sectional view similar to FIGS. 19 and 20 showing first and second hinge members when the tailgate is in the released position;

FIG. 22 is a perspective view of a hinge assembly according to another embodiment of the invention;

FIGS. 23-24 are perspective views of one type of insert member;

FIG. 25 is a perspective view of another type of insert member; and

FIGS. 26-29 are schematic views illustrating the formation of the hinge members.

### DETAILED DESCRIPTION OF ILLUSTRATED EMBODIMENTS OF THE INVENTION

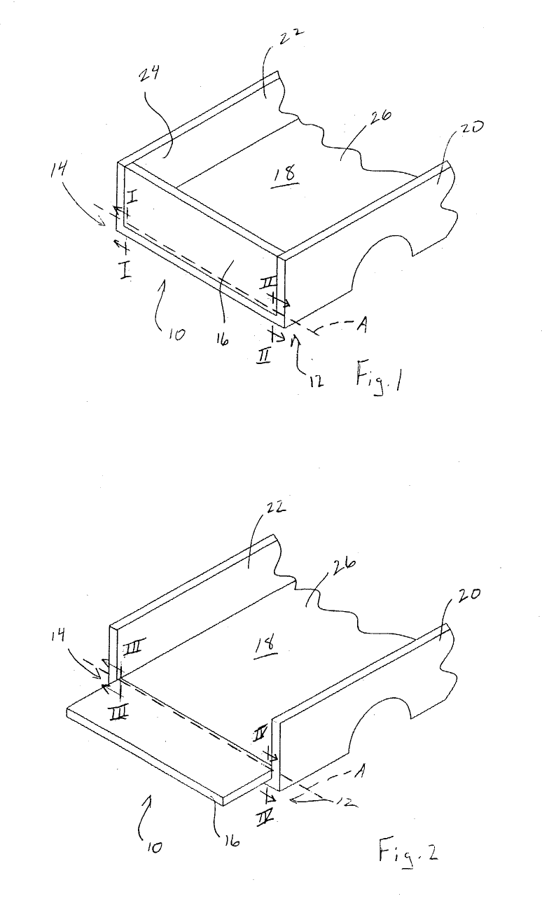

FIGS. 1 and 2 show a tailgate mounting assembly 10 including hinge assemblies 12 and 14 embodying principles of the present invention. The hinge assemblies 12, 14 are utilized to pivotally mount a vehicle closure member, such as tailgate 16 or various types of door assemblies to a vehicle body, such as truck bed 18 or rear or side portions of a vehicle body. While the tailgate mounting assembly 10 and hinge assemblies 12, 14 are described and illustrated herein with reference to connection between a truck bed and a tailgate, it is contemplated that the embodiments described and illustrated herein may be used with and/or adapted for other applications including other types of vehicles (e.g., sport utility vehicles or station wagons) and other non-automotive applications. Additionally, the mounting assembly 10 and hinge assemblies 12, 14 may be utilized in applications having doors or gates that are pivotable about a vertically extending rotational axis, rather than a horizontally extending one as shown in FIGS. 1 and 2.

The truck bed 18 includes a pair of laterally spaced side walls 20, 22. The tailgate 16 is disposed and extends between the side walls 20, 22 at rearward ends thereof. The tailgate 16 is pivotable about a pivot axis A (FIGS. 1 and 2) extending generally horizontally through a lower portion thereof relative to the truck bed 18 between a generally upright closed position, wherein the tailgate 16 and side walls 20, 22 define an upwardly open cargo holding area 24, and a generally horizontal open position, wherein the tailgate 16 is disposed generally parallel to a bed bottom 26 to provide access to the cargo area 24. The tailgate 16 may be prevented from movement past the open position thereof by tethers (e.g., cables, chains, etc.) or stops (not shown) on each end thereof. Additionally, the tethers or stops may serve to facilitate support of the tailgate 16 when in the open position. It is preferable for the tailgate 16 to be generally horizontal and/or parallel with the bed bottom 26 when in the open position to facilitate loading and unloading of cargo into or out of the cargo area 24. However, it is contemplated that the open position of the tailgate 16 may correspond to a position pivoted beyond a horizontal extent, so as to allow the tailgate to be used as a ramp.

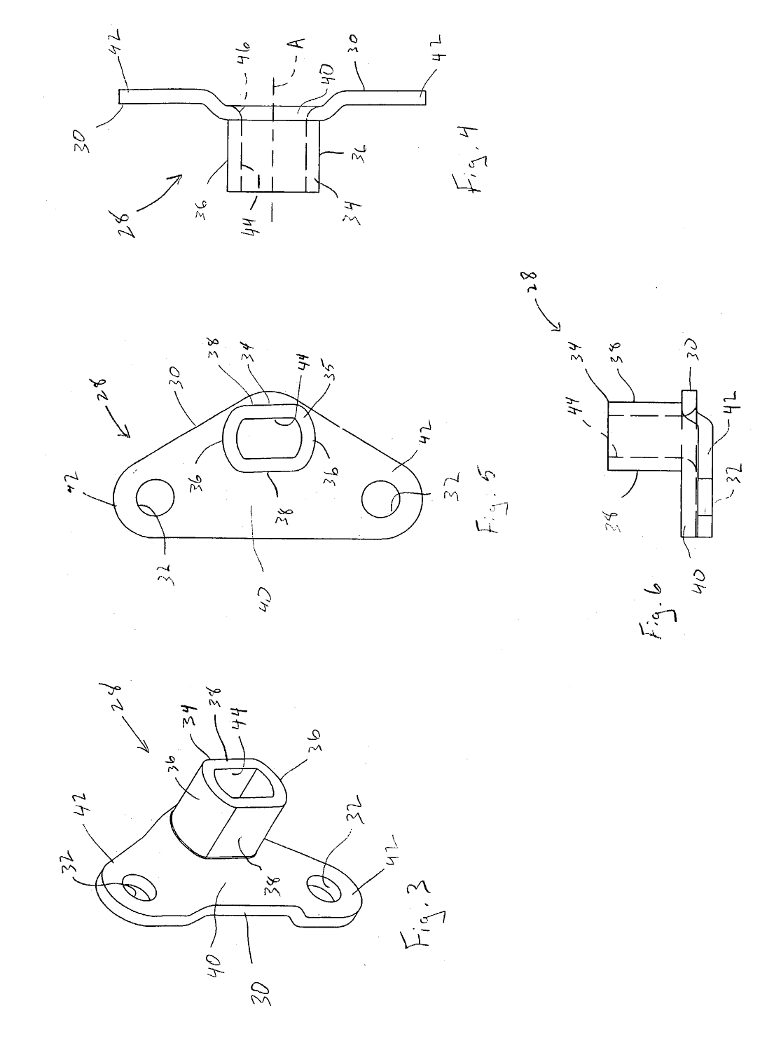

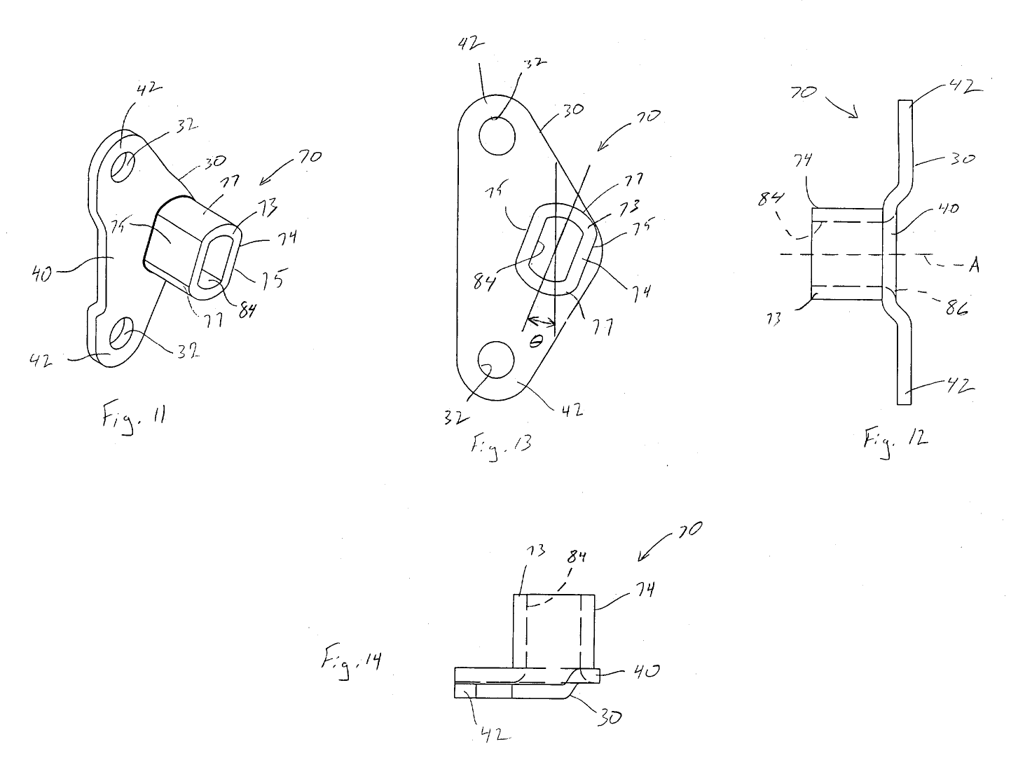

Referring to FIG. 1, each lateral end of the tailgate 16 is pivotally connected to the respective side wall 20, 22 via the hinge assemblies 12, 14. For each hinge assembly 12, 14, either of the first and second hinge members 28, 48 is connected to the tailgate 16, while the other of the hinge members 28, 48 is connected to the corresponding side wall 20, 22. However, for the embodiments of the first hinge member 28 and second hinge member 48 illustrated in FIGS. 3 and 7 respectively, the first hinge members 28 are mounted to the tailgate 16, while the second hinge members 48 are mounted to the respective side walls 20, 22.

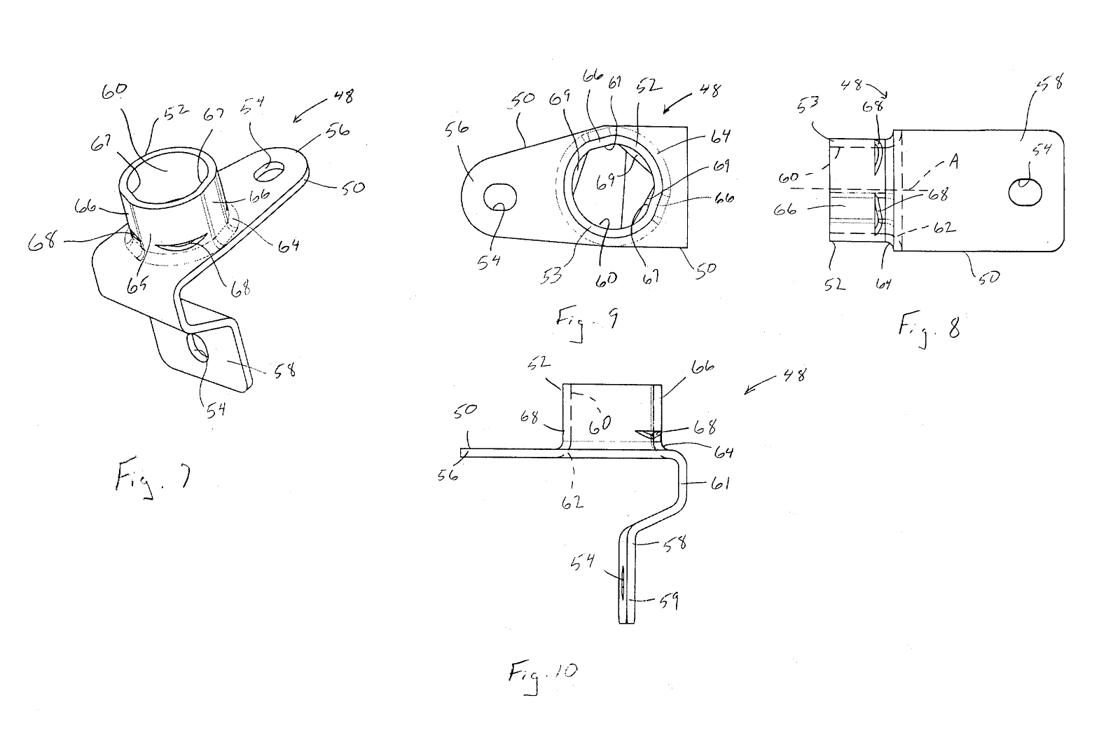

Each hinge assembly 12, 14 includes a first hinge member 28, such as shown in FIGS. 3-6. The first hinge member 28 includes a substantially plate-like mounting structure 30 for mounting the first hinge member 28 to lateral sides of the tailgate 16. As shown, the mounting structure 30 is generally triangularly-shaped and includes apertures 32 that allow fasteners (not shown) to pass therethrough to secure the mounting structure 30 to the tailgate 16. As also shown, the first hinge member 28 includes a rotatable member or shaft element 34 extending outwardly therefrom. The shaft element 34, as shown in FIG. 5, has a partially circular and somewhat oblong sectional configuration with an annular side wall 35 that defines a pair of arcuate portions 36 and a pair of flat portions 38. The flat portions 38 are diametrically opposed relative to one another, and the arcuate portions 36 are disposed at opposite ends of the flat portions 38. As shown, the shaft element 34 extends generally perpendicular from the mounting structure 30.

Additionally, the mounting structure 30 may include a ridge portion 40 as shown in FIG. 4. The ridge portion 40 is formed to be spaced outwardly from adjacent mounting portions 42 within which the apertures 32 are formed. In this manner, the spacing between the ridge portion 40 and mounting portions 42 provides clearance for, e.g., bolt heads or nuts used to secure the first hinge members 28 to the tailgate 16.

The shaft element 34 is illustrated as being formed with an axially extending bore 44. Additionally, an edge region 46 formed at an intersection of a side surface of the mounting structure 30 opposite the shaft element 34 and the internal surface of the bore 44 is formed with a radius that is uniform about the entire periphery of the bore 44. The uniform radius of the edge portion 46 is optional but advantageous in that it reduces the magnitude of stress concentration in this area, thereby increasing the strength of the hinge member 28.

The first hinge members 28 are one piece unitary bodies providing the shaft elements 34 and mounting structures 30 integrally therewith. That is, the shaft element 34 and the mounting structure 30 are integrally formed together from a single piece of metal. A progressive die forming process, as an example, may be utilized to form the first hinge members 28. In this manner, the one piece hinge members 28 do not possess the disadvantages of prior art hinges, since a secondary fastening operation is not needed to join the shaft elements 34 to the mounting structures 30, nor is there a necessity to maintain a constant orientation of the shaft elements 34 relative to the mounting structures 30 during the joining process. These advantages of the illustrated embodiment are mentioned only for illustrative purposes and are not limiting in any respect on the scope of the invention. The manufacture of the hinge member 28 is discussed in greater detail below.

Each hinge assembly 12, 14 additionally includes a second hinge member 48, as shown in FIGS. 7-10. The second hinge member 48 includes a bracket-type mounting structure 50 with a cup portion or wall structure 52 extending outwardly therefrom. The mounting structure 50 includes apertures 54 which receive fasteners therethrough to secure the second hinge member 48 to one of the side walls 20, 22 and truck bed 18. The mounting structure 50 includes a lateral connecting portion 56 from which the cup portion 52 extends generally perpendicularly from and a vertical support portion 58. As shown in FIG. 10, an outward portion 59 of the vertical support portion 58 may be slightly angled relative to an inward portion 61 thereof to accommodate a configuration of the side walls 20, 22. In the illustrated embodiment, these second mounting structures 48 are mounted to respective side walls 20, 22 and cooperate with corresponding first hinge members 28 mounted to the tailgate 16 to allow for pivotal movement of the tailgate 16. Of course, these components may be reversed with the second hinge members 48 mounted to the lateral sides of the tailgate 16 and the first hinge members 28 mounted to the side walls 20, 22. As another alternative, the first hinge member 28 may be formed with the cup portion 52, while the second hinge member 48 may be formed with the shaft element 34.

When mounted to the respective side wall 20, 22, the vertical support portions 58 of the second hinge members 48 are connected to an outwardly facing portion (not shown) of the side walls 20, 22 to facilitate the support thereof. As shown, the cup portion 52 is annular and defines a shaft element receiving space therein in the form of an axially extending bore 60. The bore 60 is configured to receive the shaft element 34 of the first mounting member 28 therein. Inner and outer edge portions 62, 64 formed between respective inner and outer side surfaces of the mounting structure 50 and the cup portion 52 are formed with an optional radius that is uniform about the entire inner and outer peripheries of the cup portion 52. Accordingly, magnitudes of stress concentrations in these areas are reduced, thereby increasing the strength of the second hinge member 48.

The second hinge member 48 is a one-piece unitary body providing the cup portion 60 and mounting structure 50 integrally therewith. A progressive die forming process, as an example, may be utilized to form the second hinge members 48. In this manner, the one piece hinge members 48 do not possess the disadvantages of prior art hinges, since a secondary fastening operation is not needed to join the cup portions 60 to the mounting structures 50, nor is there a necessity to maintain a constant orientation of the cup portions 60 and mounting structures 50 relative to the pivot axis during the joining process. These advantages of the illustrated embodiment are mentioned for illustrative purposes only and are not limiting in any respect on the scope of the invention. The manufacture of the hinge member 48 is discussed in greater detail below.

As shown in FIG. 9, a side wall 65 of the cup portion 52 may be formed with one or more flat portions 66 that extend axially along the cup portion 52. The embodiment of the second hinge member 48 illustrated in FIG. 9 shows the cup portion 52 formed with a pair of flat portions 66, which are circumferentially spaced from one another along the side wall 65. The flat portions 66 define radially inwardly facing substantially flat surfaces 67 on an interior periphery of the cup portion 52, the function of which will be discussed below.

Furthermore, the side wall 65 of the illustrated embodiment is optionally formed with a plurality of indentations 68, which create a corresponding plurality of radially inwardly extending protruding portions 69 within the interior of the cup portion 52, as shown in FIG. 9. When the shaft elements 34 of the first hinge members 28 are disposed within the interior of the cup portions 52, the protruding portions 69 serve as axial stops to limit the depth of axial insertion of the shaft elements 34 into the interior of the cup portions 52.

Additionally, it may be preferable to provide a hinge assembly on one end of the tailgate 16 that has disengageable hinge members to facilitate disconnection of the tailgate 16 from the truck bed 18. One contemplated embodiment of such a hinge assembly is described herein below and includes a first hinge member 70, shown in FIGS. 11-14, and a second hinge member 72, shown in FIGS. 15-18. The first hinge member 70 includes some identical components as the first hinge member 28 described above, which are indicated in FIGS. 11-14 by identical reference numbers.

As shown, the first hinge member 70 includes a rotatable member or shaft element 74 extending outwardly from a ridge portion 40 perpendicular to the mounting structure 30. The shaft element 74 includes a side wall 73 that defines a pair of diametrically opposed flat portions 75 and a pair of opposing arcuate portions 77 (similar to flat portions 38 and arcuate portions 36, respectively). The side wall 73 is disposed such that the major axis of the shaft element's oblong shape, which is parallel to the flat portions 75, is angled approximately 20° (θ≈20°) from a vertical direction. (See FIG. 5, which shows the flat portions 38 and major axis of the shaft element 34 angled generally parallel to the vertical direction.) Of course, the angle θ may be altered in either or both of direction and degree (e.g., between 0° and 90°), depending on the position at which it is desired to allow tailgate removal.

The shaft element 74 is formed with an axially extending bore 84. Additionally, an edge region 86 formed at an intersection of a side surface of the mounting structure 30 opposite the shaft element 74 and the bore 84 is formed with a radius that is uniform about the entire periphery of the bore 84. The uniform radius of the edge region 86 is advantageous in that it reduces the magnitude of stress concentration in this area, thereby increasing the strength of the hinge member 70.

As with the first hinge member 28, the first hinge member 70 is a one-piece unitary body providing the shaft element 74 and the mounting structure 30 integrally therewith. That is, the shaft element 74 and the mounting structure 30 are integrally formed together from a single piece of metal. It is contemplated that a progressive die forming process may be utilized to form the first hinge members 70.

As shown in FIGS. 15-18, the second hinge member 72 includes some identical components as the second hinge member 48, which are indicated with identical reference numbers. As illustrated, second hinge member 72 has a configuration that is a mirror-image to the configuration of second hinge member 48 to accommodate placement of the second hinge members 48, 72 on opposite sides of the vehicle bed 18. As shown, the second hinge member 72 includes a cup portion or wall structure 76 extending from the mounting structure 50. As with the cup portion 52, the cup portion 76 is substantially cylindrical and provides a shaft element receiving space therein in the form of an axially extending bore 71. The cup portion 76 has formed therein a radially facing opening 78 providing radial access to the shaft element receiving space. The opening 78 has a generally rectangular configuration and extends longitudinally from an outer end (end opposite the mounting structure 50) of the cup portion 76 toward the mounting structure 50. In this manner, the radially extending opening 78 is provided within a side wall 80 of the cup portion 76. The opening 78 may be formed by, for example, punching a portion of the side wall 80 radially inwardly, so as to separate from the side wall 80 a tab portion 81, which is accordingly bent radially inwardly and downwardly into a substantially radially inwardly extending position, as shown in FIGS. 16 and 17. The tab portion 81, when disposed in the radially inwardly extending position, may optionally serve as an axial stop (similar to the protruding portions 69 of the second hinge members 48) to prevent axial movement of the shaft elements 74 therepast. It is also contemplated that the first hinge member 70 may be formed with the cup portion 76, while the second hinge member 72 is formed with the shaft element 74.

As with the second hinge member 48, the second hinge member 72 is a one piece unitary body providing the cup portion 76 and mounting structure 50 integrally therewith. A progressive die forming process may be utilized to form the second hinge member 72. Additionally, inner and outer edge portions 62, 64 formed between side surfaces of the mounting structure 50 and the cup portion 76 are formed with an optional radius that is uniform about the entire outer and inner peripheries, respectively, of the cup portion 76. Accordingly, magnitudes of stress concentrations in these areas are reduced, thereby increasing the strength of the second hinge member 72.

As shown in FIG. 17, the side wall 80 of the cup portion 76 may be formed with one or more flat portions 83 that extend axially along the cup portion 76. The embodiment of the second hinge member 72 illustrated in FIG. 17 shows the cup portion 76 formed with a pair of flat portions 83, which are circumferentially spaced from one another along the side wall 80. The flat portions 83 define radially inwardly facing substantially flat surfaces 85 on an interior periphery of the cup portion 76, the function of which will be discussed below.

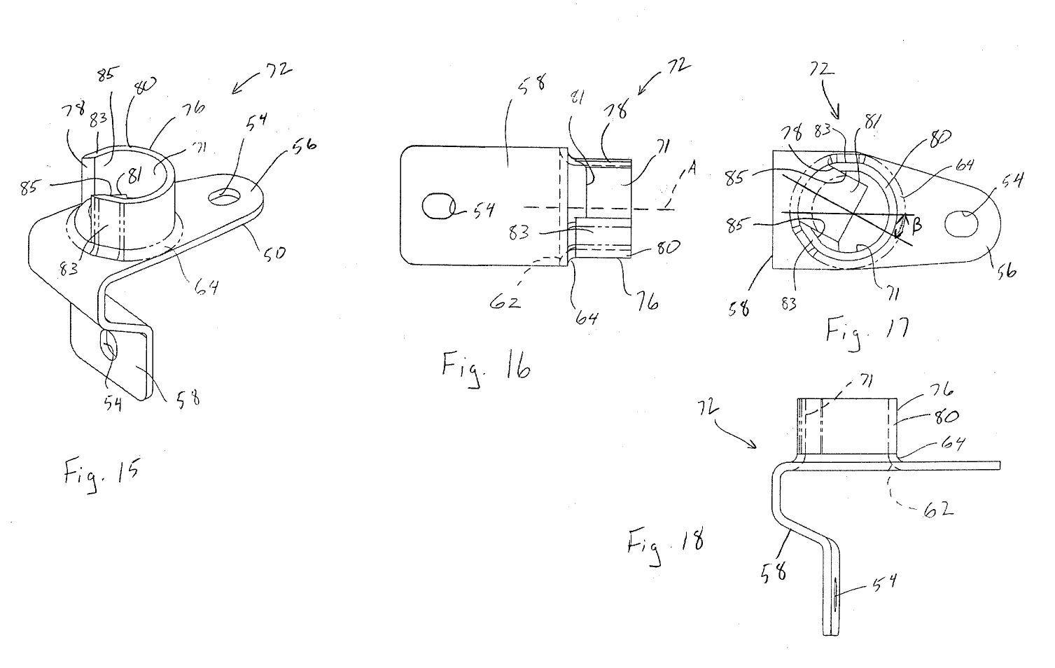

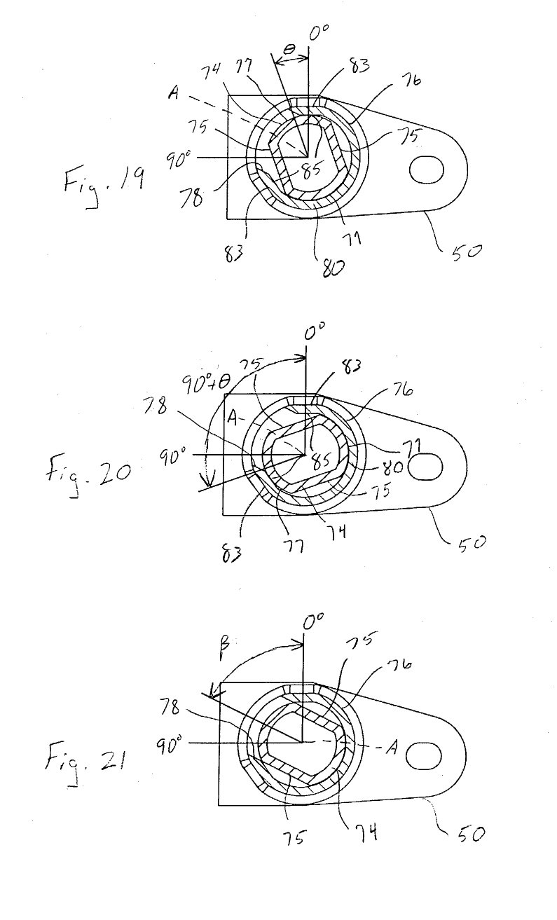

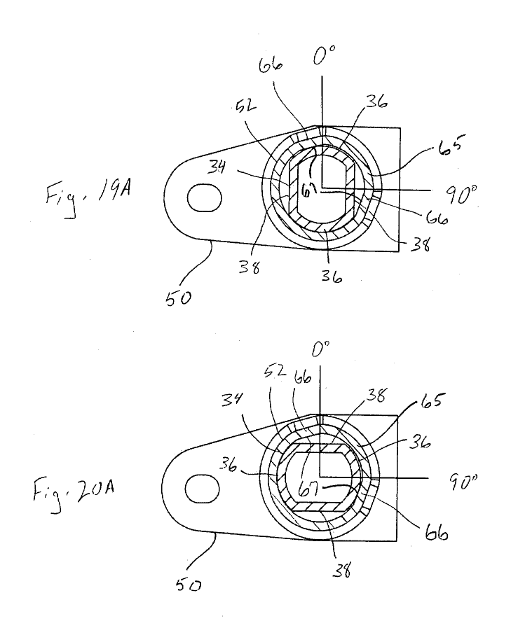

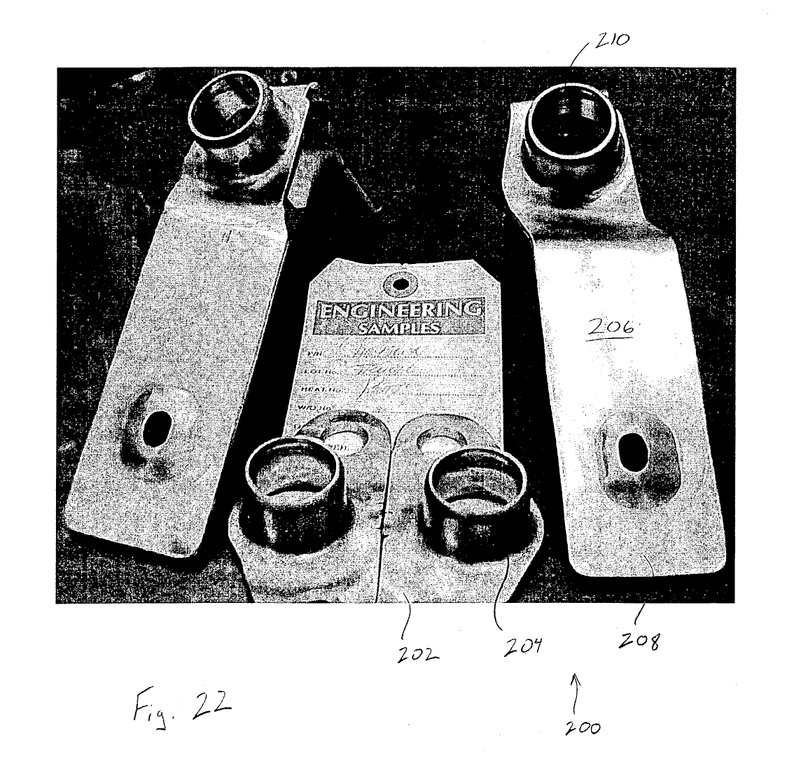

FIG. 19 shows an orientation of the cup portion 76 of the second hinge member 72 and the shaft element 74 of the first hinge member 70 when the tailgate 16 is in the closed position thereof, as shown in FIG. 1. As shown, the shaft element 74 is disposed within an inner periphery of the cup portion 76 to allow rotation of the second hinge member 72, and likewise tailgate 16, about an outer periphery of the shaft element 74. As discussed above, the shaft element 74 is disposed such that flat portions 75 thereof extend in a direction about 20° from vertical. As also discussed above, the opening 80 within the cup portion 76 faces about 30° (β≈30°) from vertical in the same angular direction of the shaft element 74. Of course, the angle β may be altered in either or both of direction and degree.

FIG. 20 shows the second hinge member 72 in an orientation relative to the shaft element 74 corresponding to an open position of the tailgate 16, shown in FIG. 2. As shown, the mounting structure 50 and cup portion 76 are rotated from the position shown in FIG. 19 relative to the shaft element 74. As can be seen from FIGS. 19 and 20, when the tailgate 16 is in the open and closed positions, the first and second mounting members 70, 72 are prevented from disengaging from one another since the breadth of the opening 80 is less than the effective width of the shaft element 74.

However, as shown in FIG. 21, the first and second hinge members 70, 72 may be rotated relative to one another such that the effective width of the shaft element 74, defined between flat portions 75 is sufficiently narrow to pass through the opening 80 within the cup portion 76. In other words, as the shaft element 74 has an oblong cross-sectional configuration, when the major axis thereof substantially aligns with the extending direction of the opening 80, the shaft element 74 may be inserted into or withdrawn from the shaft element receiving space 71 via the opening 80. Accordingly, the first and second hinge members 70, 72 may be disengaged from one another when the tailgate 16 is in an intermediate position between the open and closed positions. As illustrated in FIG. 21, the intermediate position at which point the first and second hinge members 70, 72 may be disengaged from one another corresponds to tailgate 16 being disposed at an angle of about 10° (β−θ≈10°) from vertical. However, the point at which the shaft element 74 and opening 80 align to allow the tailgate 16 to be removed may correspond to any relative position of the tailgate 16, such as a position substantially past the open position illustrated in FIG. 2. Moreover, when used in applications other than for tailgates, this disengagement point may be provided at any relative position of the closure member that is desirable by manipulating the orientation of the shaft element 74 and opening 80.

As mentioned above, the cup portions 52, 76 may have flat portions 66, 83 formed therewith that extend axially along the side walls 65, 80 of the cup portions 52, 76. Referring the FIGS. 19 and 20, the flat portions 83 are circumferentially positioned along the cup portion 76 such that the flat interior surfaces 85 of the flat portions 66, 83 abut the arcuate portions 77 when the shaft element 74 is in positions corresponding to open and closed positions of the tailgate. More particularly, as the shaft element 74 rotates relative to the cup portion 76 toward and into the open position (FIG. 20), a camming interaction between the surface 85 of the flat portion 83 and the abutting arcuate portion 77 cams the opposite arcuate portion 77 against the interior of the side wall 80 of the cup portion 76. This camming interaction effectively squeezes the shaft element 74 within the interior of the cup portion 76, thereby tightening the engagement between the shaft element 74 and cup portion 76 in order to prevent relative movement therebetween such as vibration that may lead to undesirable noise generation.

Referring to FIGS. 19A and 20A, the cup portion 52 includes the flat portions 66, which serve the same purpose as the flat portions 83 on the cup portion 76 discussed above. However, as shown, the relative circumferential positions of the flat portions 66 are different than that of the flat portions 83, due to the different orientation of the shaft element 34 relative to the shaft element 74. Additionally, as the shaft elements 34, 74 rotate toward and into the respective closed position, a camming interaction between the surfaces 67, 85 of the flat portions 66, 83 and the abutting arcuate portions 36, 77 cams the opposite arcuate portions 36, 77 against the interiors of the respective side walls 65, 80 of the cup portions 52, 76. This camming interaction effectively squeezes the shaft elements 34, 74 within the interiors of the cup portions 52, 76, thereby tightening the engagement between the shaft elements 34, 74 and cup portions 52, 76 in order to prevent relative movement therebetween such as vibration that may lead to undesirable noise generation. Furthermore, the camming interaction ensures that the tailgate 16 is moved into the same orientation relative to the vehicle body 18 each time the tailgate 16 is opened and closed so that the tailgate may be precisely aligned with body panels of the vehicle body 18 and be positioned relative thereto to have a gap therebetween on a desired size and will maintain the alignment and spacing for repeated opening and closing of the tailgate 16.

FIG. 22 shows another embodiment of a hinge assembly, indicated at 200. As shown, a first hinge member 202 is formed similarly as first hinge members 28, 70, and includes a cup portion 204 integrally formed therewith that is substantially circular in configuration. Also similarly as with the first hinge members 28, 70, the first hinge member 202 may be mounted to either of the tailgate 16 and vehicle body 18.

FIG. 22 also shows a second hinge member 206 configured to rotatably interconnect with the first hinge member 202, similarly as the second hinge members 48, 72 interconnect with the first hinge members 28, 70. The second hinge member 206 includes a bracket-type mounting structure 208 configured to connect to the other of the tailgate 16 and vehicle body 18 opposite the first hinge member 202. As shown, the mounting structure 208 is significantly elongated as compared to the mounting structure 50 described above. This allows the second hinge member 206 to be connected to a vehicle body or tailgate with different configurations as the vehicle body or tailgate that the mounting structure 50 is configured to connect to. The second hinge member 206 includes a rotatable member 210, which is substantially circular in configuration. Additionally, the rotatable member 210 is configured to be received within the cup portion 204 of the first hinge member 202 to allow the first and second hinge members 202, 206 to rotate relative to one another and provide for support and pivotal movement of a vehicle closure member. It is also contemplated that the rotatable member 210 may be formed with an oblong configuration, such as shown for shaft elements 34, 74. Additionally, the cup portion 204 may be formed with a radially outwardly facing opening to allow the oblong rotatable member to pass therethrough, such as described for the first and second hinge members 70, 72.

It is also contemplated that any pair of hinge members embodying principles of the present invention may be used singularly, such as when used with a pair of cooperating hinge members of conventional design. For instance, the first hinge members 28, 70 may be used with conventional second hinge members, while the second hinge members 48, 72 may be used with conventional first hinge members.

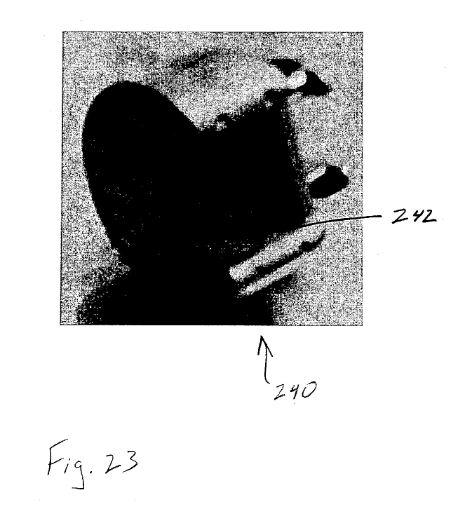

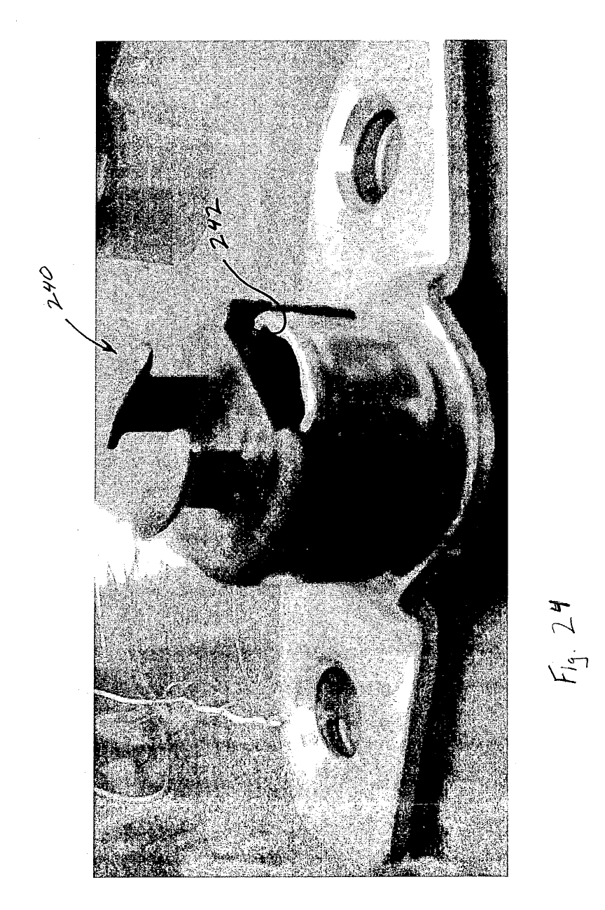

Insert members such as indicated at 240 in FIGS. 23-24 may be configured to be inserted within interiors of cup portions of one of the hinge members and each include a slot 242 formed therein to accept shaft elements of the other of the hinge members. Alternatively, insert members 244, shown in FIG. 25, may be inserted within openings within shaft elements of one of the hinge members. The insert members 240, 244 reduce relative movement between interconnected hinge members to reduce vibration therebetween and to allow more accurate alignment of the vehicle closure member (e.g., tailgate) and body panels of the vehicle.

A secondary operation may be utilized to apply a coating to the hinge members. For example, a primer, paint, powder coating, or other coating may be applied to the hinge members.

### EXEMPLARY METHODS OF MANUFACTURE

As discussed above, the cup portions (e.g., 52, 76) and shaft elements (e.g., 34, 74) are preferably formed integrally in one-piece with the respective mounting structures (e.g., 30, 50), so as to eliminate secondary joining operations, such as welding or staking. Additionally, by forming the cup portions and shaft elements as one-piece with the mounting structures, the need to align and retain the cup portions and shaft elements in position relative to respective mounting structures during the joining process is eliminated. Further, such phenomena as tolerance stacking is minimized. These advantages of the illustrated embodiment are mentioned only for illustrative purposes and are not limiting in any respect on the scope of the invention.

The hinge members 28, 48, 70, 72 may be formed of a metallic material. In this case, the material may be in the form of a sheet, roll, or plate material. A preliminary step, such as rolling, may be used to reduce the material thickness to a desired size. It is contemplated that the first step in the production of the hinge member may be to form the cup portions 52, 76 and shaft elements 34, 74 as an outwardly extending generally cylindrical protrusion 101 from a material blank 100. FIGS. 26-28 illustrate an exemplary process for forming the protrusion 101 from the material blank 100. The protrusion 101 may be draw-formed from the material blank 100 with, for example, a die 103. A punch portion 102 is forced through the material blank 100. Material of the material blank 100 conforms to the outer periphery of the punch portion 102 so as to form the substantially cylindrical shape of the protrusion 101. The periphery of the punch portion 102 is configured so that the protrusion 101 is formed with its respective features, e.g., flat portions 38, 67, 75. Further, the punch portion 102 may include a fillet edge 106, which serves to form the uniform fillet edges 46, 62, 64 of the cup portions 52, 76 and shaft elements 34, 74. As discussed previously, the uniform fillet edges 46, 62, 64 reduce stress concentrations at an intersection portion provided between the protrusion 101 and mounting structure 30, 50, which serves to strengthen the hinge members. Additionally, as the material is uninterrupted at the intersection portion (i.e., the material is continuous), the hinge members 28, 48, 70, 72 are significantly stronger at this location than prior art hinge members. Moreover, the drawing process described above serves to align the internal structure of the material (e.g., the grains and crystalline structure) of the material blank 100 in the direction of drawing, i.e., longitudinally relative to the protrusion 101 and parallel to the uniform fillet edges 46, 62, 64. This alignment of the internal structure of the material may also serve to strengthen the hinge member, especially at the intersection portion, which is not possible with previous production methods directed to joining the separately formed cup portion/shaft element to the mounting structure.

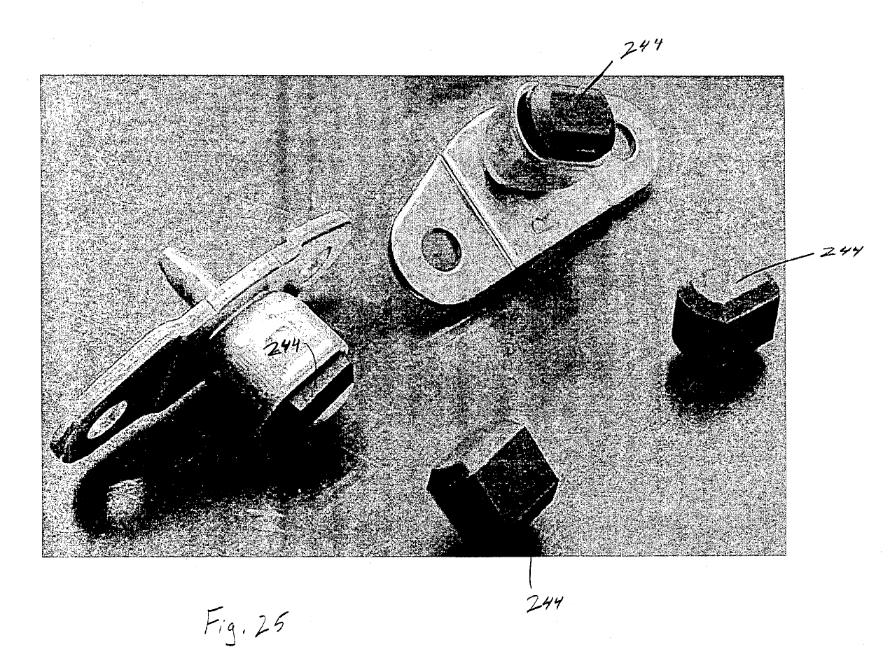

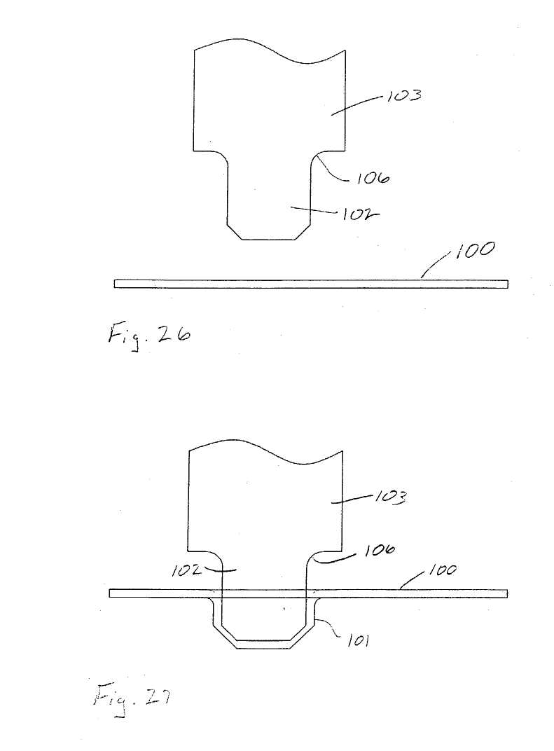

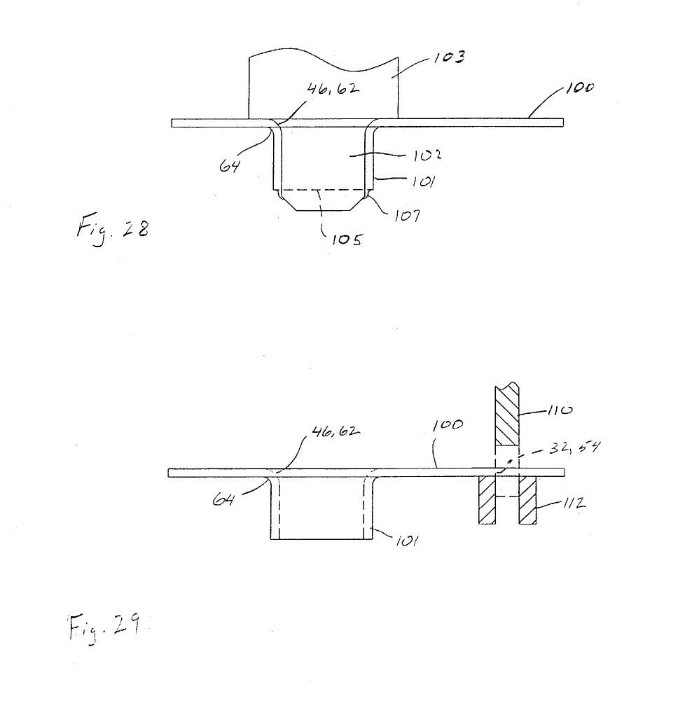

It may be preferable for the protrusion 101 to be formed first from the material blank 100. Of course, it is possible for the formation of the protrusion 101 to be performed in any order among the processes described hereinafter. It is also contemplated that a number of protrusions may be formed on a single material blank and then for the blank to be separated into corresponding individual hinge members. Following the formation of the protrusion 101 (but perhaps not directly thereafter), trim material 107 from a longitudinal outer edge portion of the protrusion 101 may be excised to remove superfluous or sharp edged trim material therefrom, as shown by the dotted line 105 in FIG. 28.

A subsequent forming process is carried out to form the material blank 100 into the general shape of the particular hinge member being formed. As discussed above, the forming process may be carried out before or after the formation of the protrusion 101. The forming process may be accomplished by use of a stamp or shearing device to remove material from the material blank 100. FIG. 29 illustrates an exemplary hinge member subsequent to drawing the protrusion 101 and stamping of the mounting structure during the forming process.

It is contemplated that the trim material 107 removed from the protrusion 101 after formation thereof, discussed above, may be carried out during the forming process. It is also contemplated that features such as the protruding portions 69 may be formed, such as by a crimping technique, may be performed during the forming process. Furthermore, it is contemplated that the tab portion 81 may be separated and deflected into the position shown in FIGS. 16 and 17 by, e.g., a punch and die during the forming process.

A piercing process is performed to form the fastening holes 32, 54 within the material blank 100, such as with use of a punch 110 and die 112. This process may be performed before or after either of the drawing process and forming process described above. It is also contemplated that the piercing process may be integrated into either of these processes. FIG. 29 illustrates a material blank 100 subsequent to forming the protrusion 101 and piercing the fastening holes 32, 54 during the piercing process. The piercing process may be accomplished with, e.g., a punch apparatus or a drill, or other suitable apparatus.

A bending process may be performed to bend the material blank 100 into the appropriate shape. The bending process may be performed before or after any of the process described above. The bending process may be accomplished by bending the material blank 100 with e.g., a brake press into, e.g., one of the shapes illustrated in FIGS. 3-18. It is also contemplated that the bending process may be accomplished with a rolling process.

The above-described processes may be performed singly with corresponding individually assigned equipment. However, the one-piece design of the hinge members may be especially suitable to progressive die forming, which may substantially increase production efficiency over individually forming the features of the hinge members.

In the broader aspects of the invention, any method may be used suitable of forming these structures so that the shaft element and/or the cup portions are integral with their respective mounting structures.

The foregoing detailed description has been provided to illustrate the structural and functional principles of the present invention and is not intended to be limiting. To the contrary, the present invention is intended to encompass all alterations, modifications, and substitutions within the spirit and scope of the following claims.

What is claimed is:

1. A hinge assembly for pivotally connecting a vehicle closure member to a vehicle body, the hinge assembly comprising:
a first hinge member including a first mounting structure configured to mount the first hinge member to one of the vehicle closure member and the vehicle body, the first hinge member also including a rotatable member extending from said first mounting structure and defining a pivot axis, the rotatable member and the first mounting structure being integrally formed together from a single piece of metal; and
a second hinge member including a second mounting structure configured to mount the second hinge member to the other of the vehicle closure member and the vehicle body, the second hinge member also including a wall portion extending from said second mounting structure to define a rotatable member receiving space, the rotatable member receiving space being configured to rotatably receive the rotatable member for enabling the first and second hinge members to pivot relative to one another about the pivot axis, the wall portion and the second mounting structure being integrally formed together from a single piece of metal.

2. A hinge assembly as in claim 1, wherein the rotatable member of the first hinge member has a generally oblong configuration and the wall portion of the second hinge member includes a radially outwardly facing opening formed therein, the opening being configured to enable the oblong rotatable member to pass through the opening when the oblong rotatable member is oriented relative to the wall portion such that a major axis of the oblong rotatable member is substantially aligned with the opening, and to otherwise prevent passage of the oblong rotatable member therethrough.

3. A hinge assembly as in claim 1, wherein the first hinge member includes an intersection portion formed between the first mounting structure and the rotatable member, the intersection portion defining inner and outer edge regions having respective essentially uniform radiuses about respective inner and outer peripheries of the rotatable member.

4. A hinge assembly as in claim 1, wherein the second hinge member includes an intersection portion formed between the second mounting structure and the wall portion, the intersection portion defining inner and outer edge regions having respective essentially uniform radiuses about inner and outer peripheries of the wall portion.

5. A hinge assembly as in claim 1, wherein the wall portion of the second hinge member includes a plurality of radially inwardly extending protruding portions, the protruding portions configured to abut an end portion of the rotatable member when the rotatable member is disposed within the rotatable member receiving space to thereby limit axial movement of the rotatable member relative to the wall portion.

6. A hinge assembly as in claim 2, wherein the wall portion includes a radially inwardly extending tab structure that is bent into the rotatable member receiving space to form the radially outwardly facing opening, the tab structure being positioned to abut an end portion of the rotatable member when the rotatable member is disposed within the rotatable member receiving space to thereby limit axial movement of the rotatable member relative to the wall portion.

7. A hinge member for use with another hinge member to define a hinge assembly for pivotally connecting a vehicle closure member to a vehicle body, the another hinge member including a mounting structure configured to mount the another hinge member to one of the vehicle closure member and the vehicle body, the another hinge member also including a rotatable member extending from the first mounting structure and defining a pivot axis, the hinge member comprising:
a mounting structure configured to mount the hinge member to the other of the vehicle closure member and the vehicle body, and
a wall portion extending from the mounting structure to define a rotatable member receiving space, the rotatable member receiving space being configured to rotatably receive the rotatable member of the another hinge member for enabling both hinge members to pivot relative to one another about the pivot axis;
the wall portion and the mounting structure being integrally formed together from a single piece of metal.

8. A hinge member as in claim 7, wherein the rotatable member of the another hinge member has a generally oblong configuration and wherein the wall portion of the hinge member includes a radially outwardly facing opening formed therein, the opening being configured to enable the oblong rotatable member to pass therethrough when the oblong rotatable member is oriented relative to the wall portion such that a major axis of the oblong rotatable member is substantially aligned with the opening, and to otherwise prevent passage of the oblong rotatable member therethrough.

9. A hinge member as in claim 7, wherein the hinge member includes an intersection portion formed between the mounting structure and the wall portion, the intersection portion defining inner and outer edge regions having respective essentially uniform radiuses about respective inner and outer peripheries of the wall portion.

10. A hinge assembly as in claim 7, wherein the wall portion of the hinge member includes a plurality of radially inwardly extending protruding portions, the protruding portions configured to abut an end portion of the rotatable member, when the rotatable member is disposed within the rotatable member receiving space to thereby limit axial movement of the rotatable member relative to the wall portion.

11. A hinge member as in claim 8, wherein the wall portion includes a radially inwardly extending tab structure that is bent into the rotatable member receiving space to form the radially outwardly facing opening, the tab structure being positioned to abut an end portion of the rotatable member when the rotatable member is disposed within the rotatable member receiving space to thereby limit axial movement of the rotatable member relative to the wall portion.

12. A hinge member for use with another hinge member to define a hinge assembly for pivotally connecting a vehicle closure member to a vehicle body, the another hinge member including a mounting structure configured to mount the another hinge member to one of the vehicle closure member and the vehicle body, the another hinge member also including a wall portion extending from the mounting structure to define a rotatable member receiving space; the hinge member comprising:
a mounting structure configured to mount the hinge member to the other of the vehicle closure member and the vehicle body; and
a rotatable member extending from the mounting structure to define a pivot axis, the rotatable member being configured to be rotatably received in the shaft receiving space for enabling both the hinge members to pivot relative to one another about the pivot axis;
the rotatable member and the mounting structure being integrally formed together from a single piece of metal.

13. A hinge member as in claim 12, wherein the hinge member includes an intersection portion formed between the mounting structure and the rotatable member, the intersection portion defining inner and outer edge regions having respective essentially uniform radiuses about respective inner and outer peripheries of the rotatable member.

14. A hinge member as in claim 12, wherein the rotatable member has a generally oblong cross-sectional configuration.

15. A hinge system for pivotally connecting a vehicle closure member to a vehicle body, the system comprising:
a pair of hinge assemblies for installation in spaced apart relation between the vehicle closure member and the vehicle body, each hinge assembly comprising:
a first hinge member including a first mounting structure configured to mount the first hinge member to one of the vehicle closure member and the vehicle body, the first hinge member also including a rotatable member extending from said first mounting structure and defining a pivot axis, the rotatable member and the first mounting structure being integrally formed together from a single piece of metal; and
a second hinge member including a second mounting structure configured to mount the second hinge member to the other of the vehicle closure member and the vehicle body, the second hinge member also including a wall portion extending from said second mounting structure to define a rotatable member receiving space, the rotatable member receiving space being configured to rotatably receive the rotatable member for enabling the first and second hinge members to pivot relative to one another about the pivot axis, the wall portion and the second mounting structure being integrally formed together from a single piece of metal;
the rotatable member of at least one of the hinge assemblies being oblong in cross-section and the wall portion of the at least one of the hinge assemblies defining an opening facing radially with respect to the pivot axis,
the opening being configured to enable the oblong rotatable member when oriented with its major axis substantially aligned with the opening to be moved through the opening so as to allow the first and second hinge members thereof to be disengaged for enabling removal of the vehicle closure member from the vehicle body.

16. A hinge system as in claim 15, wherein each first hinge member includes an intersection portion formed between the first mounting structure and the rotatable member, each intersection portion defining inner and outer edge regions having respective essentially uniform radiuses about respective inner and outer peripheries of the rotatable member.

17. A hinge system as in claim 15, wherein each second hinge member includes an intersection portion formed between the second mounting structure and the wall portion, each intersection portion defining inner and outer edge regions having respective essentially uniform radiuses about inner and outer peripheries of the wall portion.

18. A hinge system as in claim 15, wherein the wall portion of each second hinge member includes a plurality of radially inwardly extending protruding portions, the protruding portions being configured to abut an end portion of the rotatable member when the rotatable member is disposed within the rotatable member receiving space to thereby limit axial movement of the rotatable member relative to the wall portion.

19. A hinge system as in claim 15, wherein the wall portion of the at least one of the hinge assemblies includes a radially inwardly extending tab structure that is bent into the rotatable member receiving space to form the radially outwardly facing opening, the tab structure being positioned to abut an end portion of the rotatable member when the rotatable member is disposed within the rotatable member receiving space to thereby limit axial movement of the rotatable member relative to the wall portion.

20. A combination comprising:
a vehicle body;
a vehicle closure member; and
a hinge system comprising:
a pair of hinge assemblies for installation in spaced apart relation between the vehicle closure member and the vehicle body, each hinge assembly comprising:
a first hinge member including a first mounting structure mounted to one of the vehicle closure member and the vehicle body, the first hinge member also including a rotatable member extending from the first mounting structure and defining a pivot axis, the rotatable member and the first mounting structure being integrally formed together from a single piece of metal; and
a second hinge member including a second mounting structure mounted to the other of the vehicle closure member and the vehicle body, the second hinge member also including a wall portion extending from the second mounting structure to define a rotatable member receiving space, the rotatable member receiving space rotatably receiving the rotatable member therein for enabling the first and second hinge members to pivot relative to one another about the pivot axis, the wall portion and the second mounting structure being integrally formed together from a single piece of metal;
the rotatable member of at least one of the hinge assemblies being oblong in cross-section and the wall portion of the at least one of the hinge assemblies defining an opening facing radially with respect to the pivot axis,
the opening being configured to enable the oblong rotatable member, when oriented with its major axis substantially aligned with the opening, to be moved through the opening so as to allow the first and second hinge members thereof to be disengaged for enabling removal of the vehicle closure member from the vehicle body.

21. A combination as in claim 20, wherein the oblong rotatable member and the opening within the wall portion of the at least one hinge assembly are oriented such that the vehicle closure member is in a position relative to the vehicle body between 0° and 90° therefrom when the major axis of the generally oblong rotatable member is aligned with the opening of the wall portion of the at least one hinge assembly.

22. A combination as in claim 20, wherein each of the hinge members includes an intersection portion formed between the mounting structure thereof and the rotatable member or wall portion, the intersection portion defining inner and outer edge regions having respective essentially uniform radiuses about respective inner and outer peripheries of the rotatable member or wall portion.

23. A combination as in claim 20, wherein the wall portion of the other of the hinge assemblies includes a plurality of radially inwardly extending protruding portions, the protruding portions being configured to abut an end portion of the respective rotatable member positioned within the corresponding rotatable member receiving space to thereby limit axial movement of the rotatable member relative to the wall portion.

24. A combination as in claim 20, wherein the wall portion of the at least one of the hinge assemblies includes a radially inwardly extending tab structure that is bent into the rotatable member receiving space to form the radially outwardly facing opening, the tab structure being positioned to abut an end portion of the rotatable member positioned within the corresponding rotatable member receiving space to thereby limit axial movement of the rotatable member relative to the wall portion.

25. A method of forming a hinge member for use with another hinge member to define a hinge assembly for pivotally connecting a vehicle closure member to a vehicle body, the another hinge member including a mounting structure configured to mount the another hinge member to one of the vehicle closure member and the vehicle body, the another hinge member also including a rotatable member extending from the first mounting structure and defining a pivot axis, the method comprising:
providing a one-piece metal blank;
forming a wall portion protruding from the one-piece metal blank outwardly therefrom, the wall portion defining a rotatable member receiving space, the rotatable member receiving space being configured to rotatably receive the rotatable member of the another hinge member for enabling both hinge members to pivot relative to one another about the pivot axis;
forming a mounting structure from the one-piece metal blank integral with the wall portion, the mounting structure being configured to mount the hinge member to the other of the vehicle closure member and the vehicle body.

26. A method as in claim 25, wherein the rotatable member of the another hinge member has a generally oblong configuration and wherein forming the wall portion of the hinge member includes forming a radially extending opening therein, the opening being configured to enable the oblong rotatable member to pass therethrough when the oblong rotatable member is oriented relative to the wall portion such that a major axis of the oblong rotatable member is substantially aligned with the opening, and to otherwise prevent passage of the oblong rotatable member therethrough.

27. A method as in claim 25, wherein forming the hinge member includes forming an intersection portion between the mounting structure and the wall portion, the intersection portion defining inner and outer edge regions having respective essentially uniform radiuses about respective inner and outer peripheries of the wall portion.

28. A method as in claim 25, wherein forming the wall portion of the hinge member includes forming a plurality of radially inwardly extending protruding portions, the protruding portions being configured to abut an end portion of the rotatable member when the rotatable member is disposed within the rotatable member receiving space to thereby limit axial movement of the rotatable member relative to the wall portion.

29. A method as in claim 26, wherein forming the wall portion includes forming a radially inwardly extending tab structure that is bent into the rotatable member receiving space to form the radially outwardly facing opening, the tab structure being positioned to abut an end portion of the rotatable member when the rotatable member is disposed within the rotatable member receiving space to thereby limit axial movement of the rotatable member relative to the wall portion.

30. A method of forming a hinge member for use with another hinge member to define a hinge assembly for pivotally connecting a vehicle closure member to a vehicle body, the another hinge member including a mounting structure configured to mount the another hinge member to one of the vehicle closure member and the vehicle body, the another hinge member also including a wall portion extending from the mounting structure to define a rotatable member receiving space; the method comprising:
providing a one-piece metal blank;
forming a rotatable member protruding from the one-piece metal blank outwardly therefrom, the rotatable member being configured to be rotatably received within the rotatable member receiving space of the another hinge member for enabling both hinge members to pivot relative to one another about the pivot axis;
forming a mounting structure from the one-piece metal blank integral with the rotatable member, the mounting structure being configured to mount the hinge member to the other of the vehicle closure member and the vehicle body.

31. A method as in claim 30, wherein forming the rotatable member includes forming an intersection portion formed between the mounting structure and the rotatable member, the intersection portion defining inner and outer edge regions having respective essentially uniform radiuses about respective inner and outer peripheries of the rotatable member.

32. A method as in claim 30, wherein the rotatable member is formed with a generally oblong cross-sectional configuration.
